(19) United States
(12) Patent Application Publication
(10) Pub. No.: US 2011/0171411 A1
(43) Pub. Date: Jul. 14, 2011

(54) Asymmetrical Security Seal

(76) Inventor: Robert C. Jordan, St. Paul, MN (US)

(21) Appl. No.: 12/687,606

(22) Filed: Jan. 14, 2010

(51) Int. Cl. B32B 3/10; B32B 7/06; B32B 37/12

(52) U.S. Cl. 428/43; 428/202; 156/60

(57) ABSTRACT

Described herein is a multi-layered security seal having a first outer portion having a first area and a second outer portion having an equivalent area. A nonlinear center portion is positioned between the first outer portion and the second outer portion. The first outer portion, the second outer portion, and the nonlinear center portion form a single unit. The security seal has an adhesive at least partially disposed on an underside of each of the first portion, the second portion and/or the nonlinear center portion. A covert message disposed on at least one layer of the multi-layered security seal. The covert message is displayed through an upper layer of the multi-layered security seal when the multi-layer security seal is at least partially removed from an item on which it has been adhered or upon movement of an item onto which the security seal has been placed.

### TECHNICAL FIELD

The present disclosure generally relates to the field of security seals.

### BACKGROUND

There are currently a number of tamper-evident structures that undergo an irreversible and readily-observable change when the structures are peeled apart, separated or removed from an item on which they have been placed. Such tamper-evident seals are usually incorporated into closure devices such as containers, software packaging, and the like. The seals are produced in such a way that an irreversible visible change is observable when the containers or packaging have been opened. However, many times these seals may not be readily available to a home consumer. Additionally, some of these seals may be removed from packaging without triggering the irreversible visible change. One manner in which this is accomplished is by using a low-angled peel. Such a method can at times enable an individual to remove a seal having color changing properties in such a way that tampering is not evident.

### BRIEF DESCRIPTION OF THE DRAWINGS

FIG. 1A is a top view of a security seal with a removable receipt attached thereto according to embodiments.

FIG. 1B is a top view of a security seal with a removable receipt having been removed according to embodiments.

FIG. 2A is a top view of a security seal with a removable receipt attached thereto according to embodiments.

FIG. 2B is a top view of a security seal with a removable receipt having been removed according to embodiments.

FIG. 3 is a close-up side view of a security seal according to embodiments.

FIG. 4A shows a security seal adhered to an item according to embodiments.

FIG. 4B shows a security seal with a covert message revealed according to embodiments.

FIG. 4C shows a security seal with a covert message partially revealed according to embodiments.

FIG. 5 shows a security seal attached to a bottle with a removable cap according to embodiments.

FIG. 6 is a method for detecting tampering using a security seal according to embodiments.

### DETAILED DESCRIPTION

This disclosure will now more fully describe exemplary embodiments with reference to the accompanying drawings, in which specific embodiments are shown. Other aspects may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements are shown throughout are indicated with like reference numerals.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

Described herein is a multi-layered security seal having a first outer portion with a first area and a second outer portion having an equivalent area. A nonlinear center portion is positioned between the first outer portion and the second outer portion. The first outer portion, the second outer portion, and the nonlinear center portion combine to form a single unit. The security seal has an adhesive at least partially disposed on an underside of each of the first portion and the second portion. A covert message is disposed on at least one layer of the multi-layered security seal. The covert message is displayed through an upper layer of the multi-layered security seal when the multi-layer security seal is at least partially removed from an item on which it has been adhered.

Other embodiments provide a security seal having a first outer edge and a second outer edge. The first outer edge has a first area and the second outer edge has a second, different area. A nonlinear center portion having a third area is unitarily connected to the first outer edge and the second outer edge which forms a single unit. A covert message is disposed on at least one layer of the security seal and is hidden when the security seal is first placed on an object.

Still yet other embodiments provide a method for using a security seal to indicate tampering. This method includes adhering a first outer portion of the security seal to a first section of an item. A second outer portion of the security seal is adhered to a second section of the item. A nonlinear center portion that is unitarily connected to each of the first outer portion and the second outer portion of the security seal overlays at least one of the first section of the item or the second section of the item. When at least a portion of either of the first outer portion, the second outer portion or the nonlinear center portion is at least partially removed from the item, a covert message is displayed which indicates at least a portion of the seal has been removed from the item.

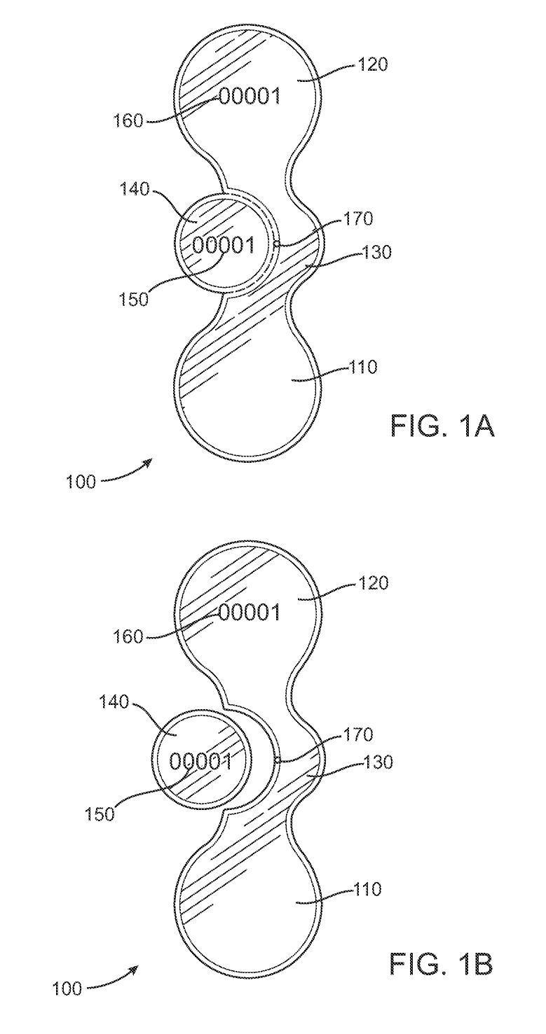

FIG. 1A is a top view of a security seal 100 with an attached receipt 140 according to embodiments. The security seal 100 has a first outer portion 110 and a second outer portion 120. The first outer portion 110 and the second outer portion 120 are unitarily joined by a nonlinear center portion 130 which creates a single seamless unit.

As will be explained in greater detail below, the security seal 100 is made up of multiple layers with each layer providing different functionality. The security seal 100 may also have a metallic sheen visible on the top layer of the security seal 100. Alternatively, the security seal 100 may have a non-metallic appearance and be colored with various dyes and/or pigment combinations. Still yet other embodiments provide that the security seal 100 may have a combination of a metallic and non-metallic appearance. For example, the security seal itself may have a non-metallic appearance while the covert message has a metallic appearance. Other combinations of metallic and non-metallic appearances of the security seal area also contemplated by this disclosure. The security seal 100 also contains a covert message which is hidden prior to the security seal 100 being adhered to an item. When the security seal is removed from an item onto which it has been placed or a portion of the security seal has been torn an irreversible color change and/or covert message will be displayed on the security seal. According to embodiments the overall dimensions of the security seal 100 is approximately 3 inches in length by 1 inch in width. However, it is contemplated that other dimensions and sizes may be used based on a particular intended use or product on which the security seal 100 will be placed.

In embodiments, the security seal 100 has an adhesive disposed entirely on an underside of each of the first portion 110, the second portion 120 and the nonlinear center portion 130. Other embodiments provide that an adhesive is disposed on portions of the underside of each of the first portion 110, the second portion 120 and/or the center portion 130. For example, an adhesive may be disposed entirely, or on portions of, each of the first portion and the second portion while the center portion may not have any adhesive disposed thereon.

According to embodiments the first outer portion 110 and the second outer portion 120 are at least partially circular. However, it is contemplated that various other shapes may be used. For example, each of the first outer portion 110 and the second outer portion 120 may be shaped to resemble a square, triangle, rectangle, octagon etc.

In embodiments, the first outer portion 110 and the second outer portion 120 have equivalent areas. In alternative embodiments, the area of one of the outer portions may be different than the area of the other outer portion even if each area has the same shape. For example, a first outer portion may be circular and have a first area while a second outer portion may also be circular but have a second, smaller area. Alternatively, the outer portions may have different shapes as well as different areas. For example, a first outer portion may be circular and have a first area while the second outer portion is rectangular and have a second area. Still yet other embodiment provide the first and second outer portions may have different shapes, (e.g., circular and rectangular) yet still have equivalent or substantially equivalent areas.

As discussed, the first outer portion 110 and the second outer portion 120 are unitarily connected to a nonlinear center portion 130. The nonlinear center portion 130 has an area that is different than the area of either the first outer portion or the second outer portion according to embodiments. Still other embodiments provide that the overall area of the nonlinear center portion 130 may be equivalent to the area of the first outer portion 110 and/or the second outer portion 120. Regardless of the overall area of the center portion 130, embodiments provide that the width of the center portion 130 may be smaller than the width of the first outer portion 110 and/or the second outer portion 120. Alternatively, the width of the center portion may be equivalent to the width of the first outer portion 110 and/or the second outer portion 120. Given the nonlinear shape of the center portion 130, the security seal 100 may better withstand tampering via a low-angled peel when there is an adhesive disposed at least partially on the underside of the center portion 130. However, in embodiments where an adhesive is not disposed on the underside of the center portion 130, the non-linear design of the center portion 130 is crucial to activating the seal when pure tension has been applied, such as for example, when the seal is applied across side to side cabinet doors and one of the doors is opened.

According to embodiments, the nonlinear center portion 130 can have various lengths. The various lengths may depend on the application of the security seal 100. For example, the nonlinear center portion should have a length sufficient to enable the first outer portion 110 of the security seal 100 to be placed on a first section of an item while enabling the second outer portion 120 of the security seal 100 to be placed on a second portion of an item.

According to embodiments and as shown in FIG. 1A, the nonlinear center portion 130 may be rounded. Other embodiments provide that the nonlinear center portion may have other nonlinear shapes, such as for example, zigzagged, sinusoidal, etc. Because of the shape and the purpose of the nonlinear center portion 130, the overall width of the nonlinear center portion may be smaller than the overall width of either the first outer portion 110 and/or the second outer portion 120. Alternatively, the width of the nonlinear center portion 130 may be equivalent, substantially equivalent or greater than the width of either the first outer portion 110 and/or the second outer portion 120. Whatever the width, when the security seal 100 has been adhered to an item and the item is opened, the act of opening the item causes lengthwise tension to be concentrated along the inner edge of the nonlinear center portion 130. The tension caused by moving or opening an item on which the seal has been placed causes activation of a covert/reveal message which indicates tampering.

The security seal 100 also includes a pre-formed perforation 170 disposed on the nonlinear center portion 130. The purpose of the pre-formed perforation 170 is to weaken the nonlinear center portion 130 which may more easily trigger the reveal message if the label is tampered with. The pre-formed perforation 170 is at least partially disposed on the nonlinear center portion 130. Alternatively, the perforation 170 may run the entire width of the nonlinear center portion 130. Other embodiments provide that multiple perforations may be disposed on different points of the nonlinear center portion 130. For example, a perforation may be placed on the center axis of the interior edge of the nonlinear center portion 130 as shown in FIG. 1A and also placed at points near either or both of each of the first outer portion 110 and the second outer portion 120. Other embodiments provide that perforations may be placed near the first outer portion 110 and the second outer portion 120 of the security seal 100 only.

The security seal 100 also includes a removable receipt 140. In embodiments, the removable receipt 140 is circular and may be removed prior to application of the security seal 100 onto an item. The removable receipt is disposed on an inner edge of the nonlinear center portion 130. Other embodiments provide that the removable receipt 140 may have any shape and may be removably disposed on any portion of the security seal 100. Still yet other embodiments provide that the receipt 140 may be associated with the security seal 100 without being physically attached (i.e., separated from the seal 100 by 1/16 of an inch). The removable receipt 140 also includes a serial number 150 disposed thereon. The serial number 150 may be alphanumeric text, a barcode and other such identifiers. A corresponding serial number 160 is disposed on either the first outer portion 110 or the second outer portion 120. The serial numbers 150 and 160 may be used to identify and track which security seal, such as for example, security seal 00001 of FIG. 1A has been placed on what item.

FIG. 1B is a top view of a security seal 100 with a detached receipt 140 according to embodiments. As explained above, the receipt 140 may be removed by a user prior to placing the security seal 100 onto an item. The act of removing the security receipt 140 does not activate the covert message. Once removed, the receipt 140 may be used for personal records such as inventory records and the like to more easily track which items particular security seals 100 have been adhered.

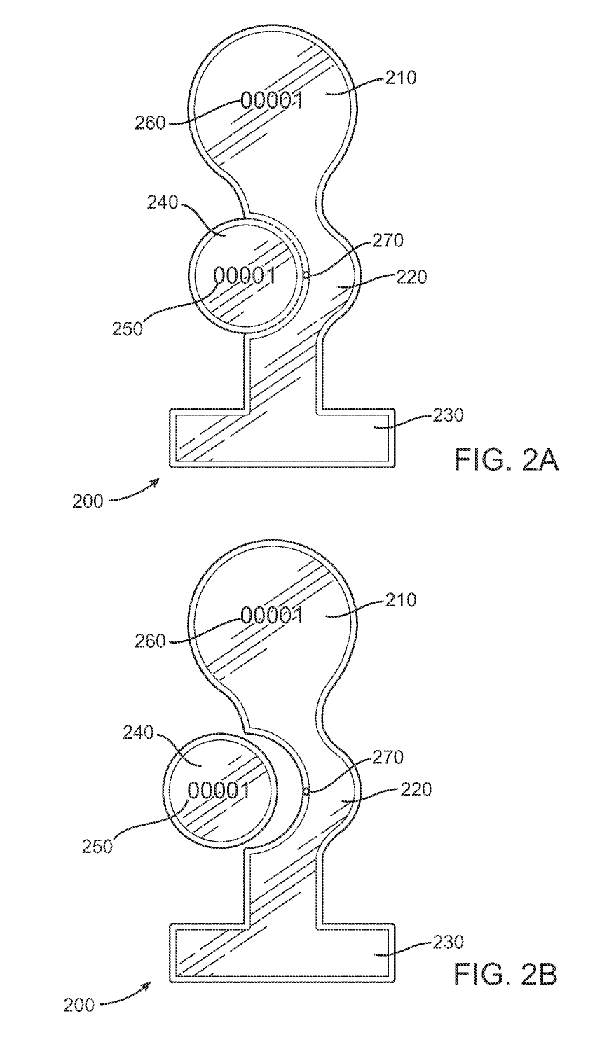

FIG. 2A is a top view of a security seal 200 with a receipt removably attached thereto according to embodiments. The security seal 200 includes a first outer portion 210 and a second outer portion 230. Embodiments provide that the first outer portion 210 is circular and has a first area while the second outer portion 230 is generally rectangular and has a second area. The rectangular shape of the second outer area 230 may be useful for placing the security seal on a rounded item such as a bottle or jar and the like. In such embodiments, a circular portion, such as for example the first outer portion 210 may be placed on a lid or removable cap of a bottle while the rectangular portion may be adhere to a neck or body of the bottle.

Although specific shapes have been mentioned, it is contemplated that any combination of shapes and corresponding areas may be used for each of the first outer portion 210 and the second outer portion 230. For example, the first outer portion may be triangular while the second outer portion is octagonal, circular or square. Additionally, each of the first outer portion and the second outer portion may have equivalent areas or different areas.

The security seal 200 also includes nonlinear center portion 220 that is unitarily connected to the first outer portion 210 and the second outer portion 230. Each of the first outer portion, the second outer portion and the nonlinear center portion 220 function as a unitary whole. There are no seams that separate any of the first outer portion 210, the second outer portion 230 and the nonlinear center portion 220. According to embodiments, the nonlinear center portion may be rounded such as shown in FIG. 2A. Other embodiments provide that the nonlinear center portion 220 may be zigzagged, sinusoidal etc. The nonlinear center portion 220 may have an area that is smaller than either the first outer portion 210 and/or the second outer portion 230. Alternatively, the area of the nonlinear center portion 220 may have an area that is equivalent, substantially equivalent, or greater than the area of the first outer portion 210 and/or the second outer portion 230.

A perforation 270 may also be disposed on an inner edge of the nonlinear center portion 220 of the security seal 200. The perforation 270 weakens the nonlinear center portion 220 which may cause the covert message to more readily be displayed when the security seal 200 is tampered with once it has been adhered to an item. According to embodiments, the pre-formed perforation 270 is at least partially disposed on the nonlinear center portion 220. Other embodiments provide that the perforation may be disposed throughout the entire width of the nonlinear center portion 220. Still yet other embodiments provide that multiple perforations may be disposed on different points of the nonlinear center portion 220.

The security seal 200 also includes a receipt 240 removably coupled to the security seal 200. Alternatively, the receipt may be associated with the security seal 200 without being physically attached. The receipt 240 includes a serial number 250 disposed thereon that may be used to identify products and items onto which the security seal 200 has been placed. Embodiments provide that a matching serial number 260 is disposed on at least a first outer portion 210 of the security seal 200. The serial numbers 250 and 260 may be alphanumeric text, barcodes or other such identifiers.

FIG. 2B is a top view of a security seal 200 with a detached receipt 240 according to embodiments. As explained above, the receipt 240 may be removed by a user prior to placing the security seal 200 onto an item such as a folder, a cabinet, a bottle with a removable cap etc. The act of removing the security receipt 140 does not activate the hidden covert message. Once removed, the receipt 240 may be used to track which security seal 200 has been placed on which items.

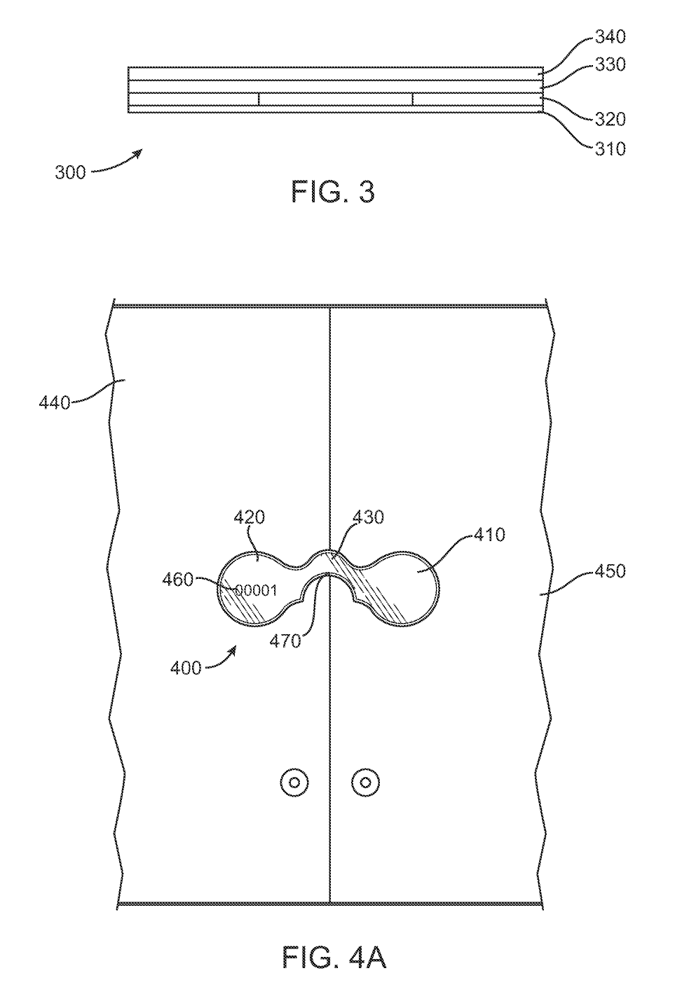

FIG. 3 is a close-up side view of a security seal 300 according to embodiments. The construction of the security seal 300 described in reference to FIG. 3 may also be the construction of the security seals of FIGS. 1A-2B. Therefore the description of FIG. 3 may refer to at least one component described in FIGS. 1A-2B. However, any references to components of FIGS. 1A-2B are for descriptive purposes only. Furthermore the construction and materials used to create the various layers of the security seals of the present disclosure are more fully described in U.S. Pat. No. 4,837,061 entitled Tamper-evident structures, U.S. Pat. No. 5,149,386 entitled Tamper-evident structures, U.S. Pat. No. 5,135,262 entitled Method of making color change devices activatable by bending and product thereof, and U.S. Pat. No. 5,282,650 entitled Color change devices activatable by bending each of the disclosures are hereby incorporated by reference in their entirety.

According to embodiments, the security seal 300 has multiple layers. The layers include a release liner layer 310, a pressure sensitive adhesive layer 320, a combination plastic film layer 330, and a top layer 340. The release liner layer 310 is the bottom layer of the security seal 300. According to embodiments, the release liner layer 310 is 0.003 inches thick and comprises a removable “low-adhesion” plastic or paper film that is used to transport the seal. The release liner layer 310 is disposed entirely on the underside of the security seal 300. In embodiments where an adhesive layer is disposed on separate portions, such as, for example, the first outer portion and/or the second outer portion, the release liner layer 310 may be disposed only on those portions. Regardless of the configuration of the of release liner layer 310 on the security seal 300, the release liner layer 310 is removed, or at least partially removed, prior to the security seal 300 being adhered to an item.

The pressure sensitive adhesive layer 320 provides adhesion to an item onto which the security seal 300 will be placed. According to embodiments, the adhesive is pressure sensitive and is approximately 0.002 inches thick. In embodiments, the adhesive covers the entire bottom surface area of the security seal 300. Thus, the adhesive is disposed on the bottom side of each of the first outer portion 110, the second outer portion 120 and the nonlinear center portion 130. Other embodiments provide that the adhesive may be selectively placed on the underside of each portion of the security seal 300. Still other embodiments provide that the adhesive may be placed on portions of the undersides of each of the first outer portion 110, the second outer portion 120 and the nonlinear center portion 130.

Embodiments provide that the adhesive used on the adhesive layer 320 is a non-residue adhesive. Thus, when a security seal is removed from an item, there is no adhesive residue left on the item. Therefore, a new security seal may be reapplied to the same item on the same location without affecting the hold of the new security seal. Although a non-residue adhesive is specifically mentioned, it is contemplated that any type of adhesive may be used to secure the security seal 100 to an item.

The combination plastic film layer 330 includes a combination of a plastic film layer and an aluminum/optical thin film layer. Other embodiments provide that the plastic film layer 330 comprises a combination of a plastic film layer and an activatable covert image layer that uses release coating and organic dyes and/or pigments. Although specific examples have been mentioned, it is contemplated that any combination of materials and/or pigments or dyes may be used to activate the covert message. In embodiments, the plastic film layer is 0.002 inches thick while the aluminum/optical thin film layer is 0.0003 inches thick. The combination plastic film layer 330 contains the covert message which is revealed when tampering has occurred. Additionally, the combination plastic film layer provides the security seal 300 with a metallic appearance. In embodiments where the security seal has a non-metallic appearance, various dyes and/or pigment combinations are also present on the plastic film layer 330.

The top layer 340 of the security seal 300 is comprised of printable clear plastic. The top layer is about 0.001 inches thick and enables the covert message to be seen therethrough. Serial numbers 150 and 160 may be printed on the top layer 340. Other embodiments provide that a logo, trademark, tradename etc. may also be printed on the top layer 340 of the security seal 300.

Although specific measurements and dimensions have been given, it is contemplated that various other thicknesses may be used based on the application of the security seal. As such, the present disclosure should not be limited by the specific dimensions disclosed herein.

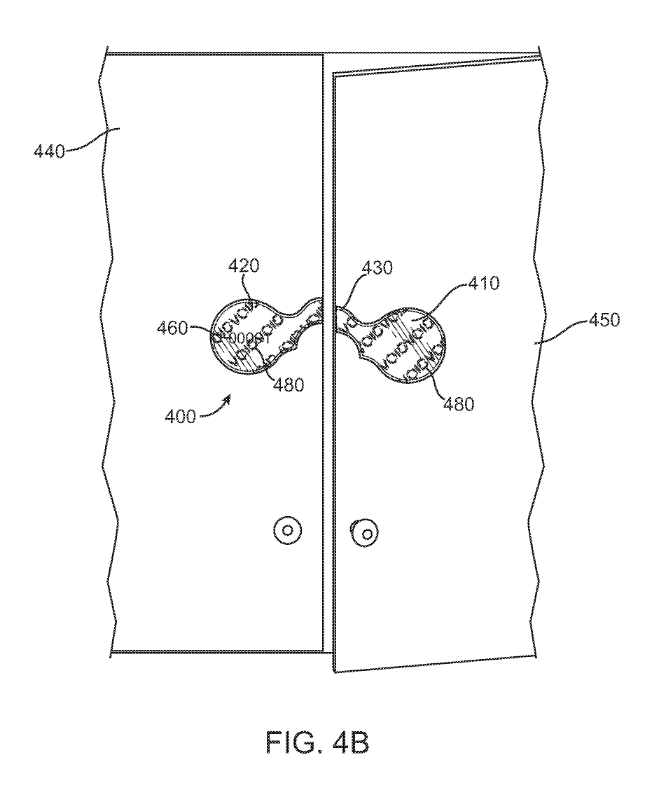

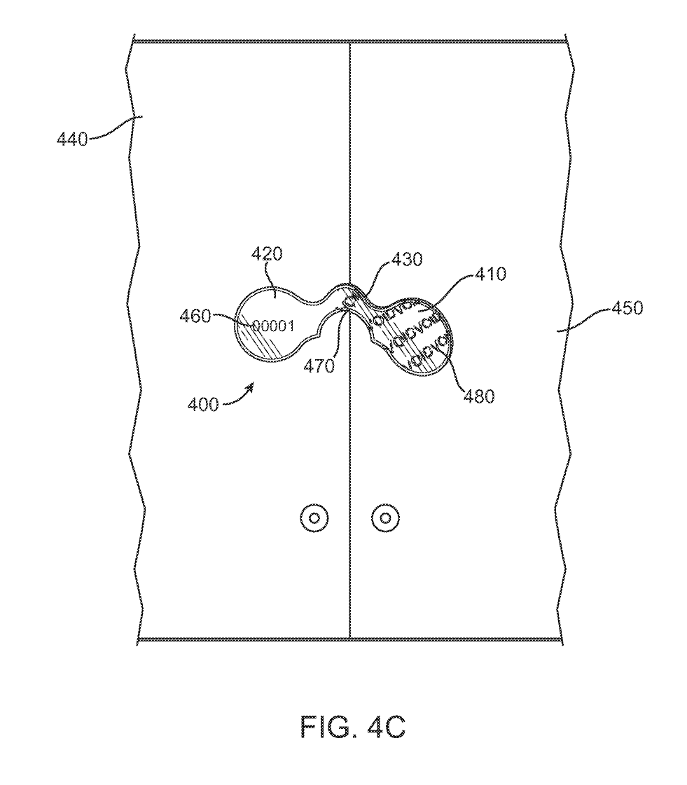

FIG. 4A shows a security seal 400 adhered to an item according to embodiments. As discussed above, the security seal 400 includes a first outer portion 410, a second outer portion 420 and a nonlinear center portion 430. Embodiments provide that a perforation 470 is disposed at least partially on the nonlinear center portion 430. The perforation enables catastrophic tearing and breaking of the security seal 400 when tampered with. Once torn, the hidden covert message will be revealed near the torn portion of the security seal 400.

The security seal 400 also includes a serial number 460 disposed on a top layer. The serial number 460 may be used to identify that a particular security seal, (e.g. security seal 00001) was placed on a particular item such as a cabinet. A receipt, such as for example, receipt 140 (FIG. 1) may have a corresponding serial number printed thereon and may be used to identify and track items onto which security seals have been placed.

As shown in FIG. 4A, when placing the security seal 400 on an item, such as for example, a cabinet having two adjacent doors, drawers etc, the first outer portion 410 of the security seal 400 is adhered to a first section 450 (e.g., a first cabinet door) and the second outer portion 420 of the security seal 400 is adhered to a second section 440 (e.g., a second cabinet door). The nonlinear center portion 430 may be placed over the opening of the cabinet such as shown by FIG. 4A.

FIG. 4B shows a security seal 400 with a covert message 480 revealed due to tampering according to embodiments. Once a security seal 400 has been placed on an item as described above with reference to FIG. 4A, if the security seal 400 is tampered with or removed, or the item on which the security seal has been placed is opened, the covert message 480 is revealed. According to embodiments, the covert message may show the word “VOID”. Other embodiments provide that other messages may be used and revealed based on the particular application of the security seal.

As shown in FIG. 4B, the covert message is displayed because the nonlinear center portion 430 was torn. The tearing action caused by cabinet door 450 being opened triggers the covert message 480. According to embodiments, the covert message may only appear on the nonlinear center portion 430 and areas near the tear. Other embodiments provide that the covert message 480 may be displayed on the entire security seal 400.

In embodiments, a perforation, such as perforation 470 (FIG. 4A) may be used to more readily indicate tampering. For example, if a security seal was placed on cabinet doors as described above with reference to FIG. 4A, and either cabinet door 440 or cabinet door 450 had been even slightly opened, the perforation 470 may be at least partially torn due to the stress caused by one of the doors being moved or partially opened. Further, the tearing or rupturing of the perforation causes the covert message to be at least partially revealed. Thus, a user is able to discover any tampering that has occurred in relation to the item on which the security seal 400 was placed.

FIG. 4C shows a security seal 400 with a covert message 480 being partially revealed due to tampering according to embodiments. According to embodiments, a covert message 480 is revealed when at least a portion of the security seal 400 has been removed from the item on which it has been placed. For example, a first outer portion 410 of the security seal 400 may be placed on a first section 450 of an item, such as a cabinet door, and a second outer portion 420 of the security seal 400 may be placed on an adjacent, second section 440, such as a second cabinet door. When at least a portion of the first outer portion 410 of the security seal 400 is removed from the first section 450, the covert message 480 is revealed on the first outer portion. Because of the shape of the nonlinear portion 430, as the security seal 400 is peeled from an item, peeling the nonlinear portion 430 will cause localization of stress along one edge of the nonlinear portion which will trigger the covert message 480. Thus, the shape of the nonlinear center portion 430 prevents non-activation of a covert message due to low-angle peel in cases when an adhesive is at least partially disposed on an underside of the nonlinear center portion. In instances when there is no adhesive disposed on the underside of the nonlinear center portion, activation of the covert message will occur when the nonlinear center portion is at least partially torn due to the tension caused by opening the item over which the nonlinear center portion is at least partially placed.

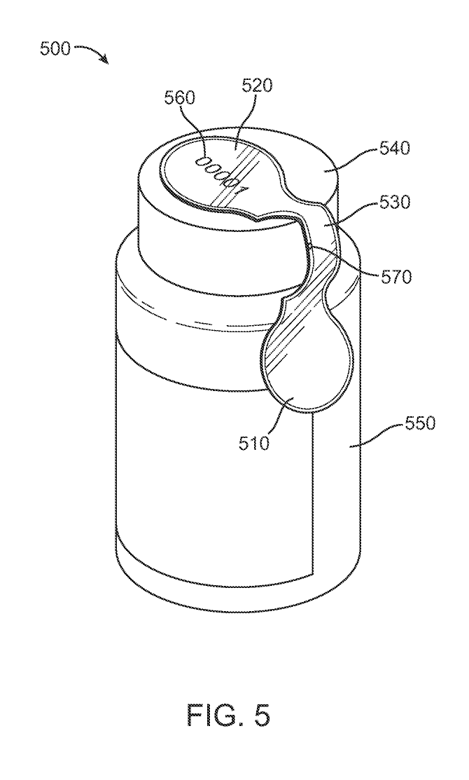

FIG. 5 shows a security seal 500 being attached to a bottle 550 having a removable cap 540 according to embodiments. The security seal 500 may be the security seal described with reference to FIG. 1A and constructed similarly to the security seal 300 of FIG. 3. Other embodiments provide that the security seal 500 may be the security seal 200 described with reference to FIG. 2A and constructed similarly to the security seal 300 of FIG. 3. According to embodiments, a first outer portion 510 of the security seal 500 may be adhered directly to the bottle 550. As described above, the first outer portion 510 may be circular. Alternatively, the first outer portion may be rectangular so as to better fit around a rounded object such as the bottle 550. A second outer portion 520 of the security seal 500 may be adhered to a removable cap 540. Finally, a nonlinear center portion 530 may be partially adhered to the cap 540 and/or the bottle 550.

As previously described, the nonlinear center portion includes a perforation 570 disposed at least partially thereon. In application such as the one described above, if the removable cap 540 is partially twisted or turned, the twisting or turning motion will cause stress on at least a portion of the nonlinear center portion 530. The stress will cause the covert message to be revealed either by partially tearing the nonlinear center portion and/or removing a section of the nonlinear center portion 530 that was adhered to the bottle 550 and/or cap 540.

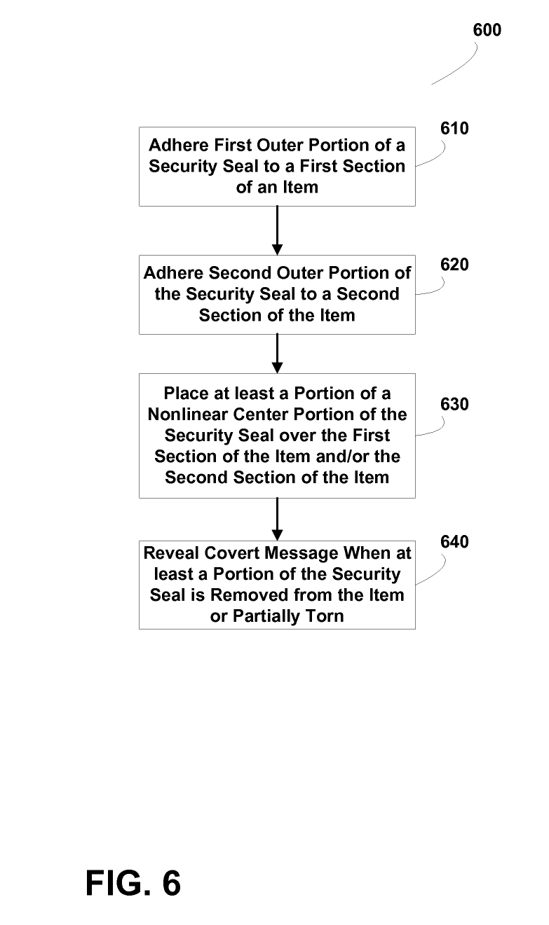

FIG. 6 shows a method 600 for detecting tampering of an object using a security seal according to embodiments. Accordingly, the method of FIG. 6 may be performed by a security seal such as those described herein with reference to FIGS. 1A-1B.

Step 610 provides that a first outer portion of a security seal having a hidden covert message is adhered to a first section of an item. Embodiments provide that the first outer portion is circular and has an adhesive backing. However, it is contemplated that the first outer portion may be shaped as a square, rectangle or other such shape.

Step 620 provides that a second outer portion of a security seal having a hidden covert message is adhered to a second section of the item. As with the first outer portion, the second outer portion is generally circular and has an adhesive backing. However it is contemplated that the second outer portion may have a different shape.

In step 630 at least a portion of a nonlinear center portion is placed at least partially over the first section of the item and/or the second section of the item. Thus, the nonlinear center portion may be at least partially adhered to the first section of the item and/or the second section of the item or merely placed over each or either section of the item. According to embodiments, the nonlinear center portion is unitarily joined with the first outer section and the second outer section to make a single seamless unit.

Step 640 provides that a covert message is revealed when at least a portion of the security seal is removed from the item and/or partially torn due to tension. According to embodiments, the covert message may be displayed on the portion of the security seal that was removed from the time. For example, a portion of the nonlinear center portion of the security seal was removed from the item, the covert message will be displayed on that portion only. Due to the shape of the nonlinear center portion, the covert message may be more readily revealed. The shape of the nonlinear center portion increases the stress on an inner center axis of the nonlinear center portion which triggers the covert message and/or color change associated with the covert message.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A multi-layered security seal, the security seal comprising:
a first outer portion having a first area;
a second outer portion having the first area;
a nonlinear center portion positioned between the first outer portion and the second outer portion wherein the first outer portion, the second outer portion, and the nonlinear center portion form a single unit;
an adhesive at least partially disposed on an underside of each of the first portion and the second portion; and
a covert message disposed on at least one layer of the multi-layered security seal, wherein the covert message is displayed through an upper layer of the multi-layered security seal when the multi-layer security seal is at least partially removed from an item on which the multi-layered security seal has been placed.

2. The multi-layered security seal of claim 1, further comprising a pre-formed perforation disposed at least partially on the nonlinear center portion.

3. The multi-layered security seal of claim 2, wherein the covert message is at least partially displayed when the pre-formed perforation is at least partially separated.

4. The multi-layered security seal of claim 1, further comprising a serial number disposed on at least one of the first outer portion and the second outer portion.

5. The multi-layered security seal of claim 1, further comprising a receipt, wherein the receipt is associated with the multi-layered security seal.

6. The multi-layered security seal of claim 5, further comprising a serial number disposed on the receipt.

7. The multi-layered security seal of claim 5, further comprising a receipt removably disposed on the nonlinear center portion.

8. The multi-layered security seal of claim 1, wherein at least one layer of the multi-layered security seal has either (i) a metallic appearance, (ii) a non-metallic appearance, and (iii) a combination thereof.

9. A security seal comprising:
a first outer edge having a first area;
a second outer edge having a second area, wherein the second area is different than the first area;
a nonlinear center portion having a third area, wherein the nonlinear center portion is unitarily connected to the first outer edge and the second outer edge; and
a covert message disposed on a first layer of the security seal, wherein the covert message is hidden when the security seal is first placed on an object.

10. The security seal of claim 9, wherein at least one of the first outer edge and the second outer edge is at least partially circular.

11. The security seal of claim 9, wherein the second outer edge is rectangular.

12. The security seal of claim 9, wherein the covert message is displayed on at least a portion of the asymmetric security seal that has been removed from the object on which it was placed.

13. The security seal of claim 9 further comprising a perforation at least partially disposed on the asymmetric center portion.

14. The security seal of claim 9, further comprising a receipt that is associated with the security seal.

15. The security seal of claim 14, further comprising a serial number disposed on the removable receipt.

16. The security seal of claim 15, further comprising a serial number disposed on at least one of the first outer edge and the second outer edge, wherein the serial number disposed on at least one of the first outer edge and the second outer edge corresponds to the serial number disposed on the removable receipt.

17. A method for using a security seal to indicate tampering, the method comprising;
adhering a first outer portion of the security seal to a first section of an item;
adhering a second outer portion of the security seal to a second section of the item;
placing a nonlinear center portion of the security seal over at least one of the first section of the item or the second section of them item, wherein the nonlinear center portion, the first outer portion and the second outer portion are unitary;
when at least a portion of either of the first outer portion, the second outer portion or the nonlinear center portion is at least partially removed from the item, displaying a reveal message to indicate tampering.

18. The method of claim 17 further comprising removing a receipt from the security seal prior to adhering the first outer portion, the second outer portion and the nonlinear center portion to the item.

19. The method of claim 18, wherein the receipt has a serial number that corresponds to a serial number disposed on at least one of the first portion, the second portion or the nonlinear center portion.

20. The method of claim 17 wherein the nonlinear center portion has a pre-formed perforation disposed thereon.
